(19) United States
(12) Patent Application Publication
(10) Pub. No.: US 2018/0287439 A1
(43) Pub. Date: Oct. 4, 2018

(54) PERMANENT MAGNET ELECTRIC MACHINE

(71) Applicant: Ford Global Technologies, LLC, Dearborn, MI (US)

(72) Inventors: Michael W. DEGNER, Novi, MI (US); Feng LIANG, Troy, MI (US); Kewei XIAO, Dearborn Heights, MI (US)

(21) Appl. No.: 15/472,975

(22) Filed: Mar. 29, 2017

(51) Int. Cl. H02K 1/27; H02K 1/28; H02K 1/30

(52) U.S. Cl. CPC H02K 1/2706; H02K 1/30; H02K 1/28

(57) ABSTRACT

An electric machine includes a stator and a rotor supported for rotation within the stator. The rotor includes a core of stacked laminations each having a hub portion and pole portions cooperating to define pockets. Magnets are disposed in the pockets. Bonding material is also disposed in the pockets. Each of the pole portions has a projection embedded in the bonding material to create a mechanical connection between the pole portions and the bonding material.

### TECHNICAL FIELD

The present disclosure relates to permanent magnet electric machines, and more specifically to electric machines having improved magnetic flux delivery to the stator by removing one or more bridges from the laminations of the rotor.

### BACKGROUND

Many automobile manufacturers are producing electric and hybrid-electric vehicles to improve fuel economy and reduce pollution. These vehicles include a traction battery and one or more electric machines powered by the battery. Each electric machine includes a stator and a rotor that is supported for rotation within the stator. The rotor is mounted on a shaft that is driveably connected to the driven wheels by one or more powertrain components. Torque produced by the electric machine is sent to the driven wheels by the powertrain components to propel the vehicle.

### SUMMARY

According to one embodiment, an electric machine includes a stator and a rotor supported for rotation within the stator. The rotor includes a core of stacked laminations each having a hub portion and pole portions cooperating to define pockets. Magnets are disposed in the pockets. Bonding material is also disposed in the pockets. Each of the pole portions has a projection embedded in the bonding material to create a mechanical connection between the pole portions and the bonding material.

According to another embodiment, a rotor includes a rotor core defining axially extending pockets circumferentially arranged within the core. Magnets are disposed in the pockets. Bonding material is also disposed in the pockets and has raised portions that extend out of each pocket beyond an end of the core. A ring is disposed on the end and engages with the raised portions to bias the magnets towards a center of the core.

According to yet another embodiment, a rotor includes a cylindrical rotor core having a hub portion with radially projecting spokes that define slots therebetween. The rotor core further has pole portions each disposed in one of the slots such that the pole portions are not directly connected to the hub portion. A magnet is disposed in each of the slots between the hub portion and a corresponding pole portion. A non-magnetic connection attaches each of the pole portions to the hub portion.

### BRIEF DESCRIPTION OF THE DRAWINGS

FIG. 1 is a diagrammatical side view, in cross section, of an electric machine.

FIG. 2 is a perspective view of a prior art rotor.

FIG. 3 is a perspective view of a rotor prior to potting.

FIG. 4 is a perspective view of the rotor of FIG. 3 post potting.

FIG. 5 is a magnified top view of a portion of rotor shown in FIG. 3.

FIG. 6 is a perspective view the rotor of FIG. 3 having rings.

FIG. 7 is a perspective view of another rotor prior to potting.

FIG. 8 is a perspective view of the rotor of FIG. 7 post potting.

FIG. 9 is a perspective view of yet another rotor prior to potting.

FIG. 10 is a perspective view of the rotor of FIG. 9 post potting.

FIG. 11 is a perspective view of the rotor of FIG. 9 having rings according to one embodiment.

FIG. 12 is a perspective view of the rotor of FIG. 9 having rings according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

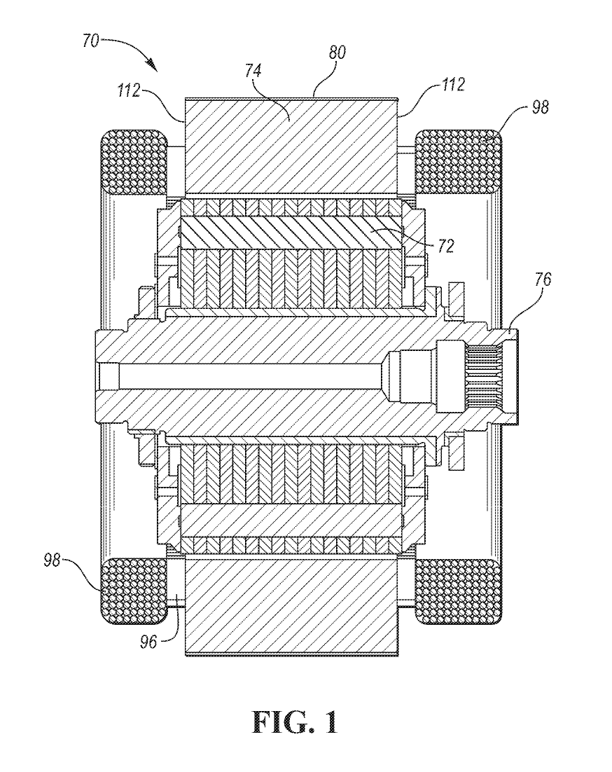

Referring to FIG. 1, an electric or hybrid electric vehicle may include an electric machine 50 for propelling the vehicle. The electric machine 50 may act as a motor and/or a generator depending upon operating conditions. The electric machine 50 may be a permanent magnet AC machine. While described as an electric machine for a vehicle, the electric machine 50 may be used in a wide range of applications.

The electric machine 50 may include a stator 52 having a plurality of laminations (not shown). Each of the laminations includes a front side and a back side. When stacked, the front and back sides are disposed against adjacent back and front sides to form a stator core 58. Each of the laminations may be doughnut shaped and define a hollow center. Each lamination also includes an outer diameter (or outer wall) and an inner diameter (or inner wall). The outer diameters cooperate to define an outer surface of the stator core 58, and the inner diameters cooperate to define a cavity 60.

Each lamination may include a plurality of teeth extending radially inward toward the inner diameter. Adjacent teeth cooperate to define slots. The teeth and the slots of the laminations are aligned with each other to define stator slots extending through the stator core 58 between the opposing end faces 62. The end faces 62 define the opposing ends of the core 58 and are formed by the first and last laminations of the stator core 58. A plurality of windings (also known as coils, wires, or conductors) 64 are wrapped around the stator core 58 and are disposed within the stator slots. The windings 64 may be disposed in an insulating material (not shown). Portions of the windings 64 generally extend in an axial direction along the stator slots. At the end faces 62 of the stator core, the windings may bend to extend circumferentially around the end faces 62 of the stator core 58 forming end windings 66. While shown as having distributed windings, the windings could also be of the concentrated type.

A rotor 54 is disposed within the cavity 60 and supported for rotation relative to the stator 52, which is typically a stationary component. The rotor 54 has a rotor core 56 that may be formed of a plurality of stacked laminations 68. The laminations are typically steel plates but may be formed of any material having a high magnetic permeability. Each of the lamination 68 may define one or more magnet pockets 70 that divide each lamination 68 into a central hub portion 72 and a plurality of pole portions 74 circumferentially arranged around the hub portion 72 near the periphery 80 of the rotor core 56. A plurality of magnets 78 are embedded in the rotor core 56 with each magnet 78 being disposed in one of the pockets 70 and extending axially through the rotor core 56. The magnets 78 are located at the poles of the rotor 54.

The rotor 54 may be supported on a shaft 82 and positioned inside the stator 52 so that an air gap 84 is formed between the rotor 54 and the stator 52. When current is supplied to the stator 52, a rotating magnetic field is created in stator causing the rotor 54 to spin within the stator 52 generating a torque. The shaft 82 is configured to output the torque to another component such as a gearbox.

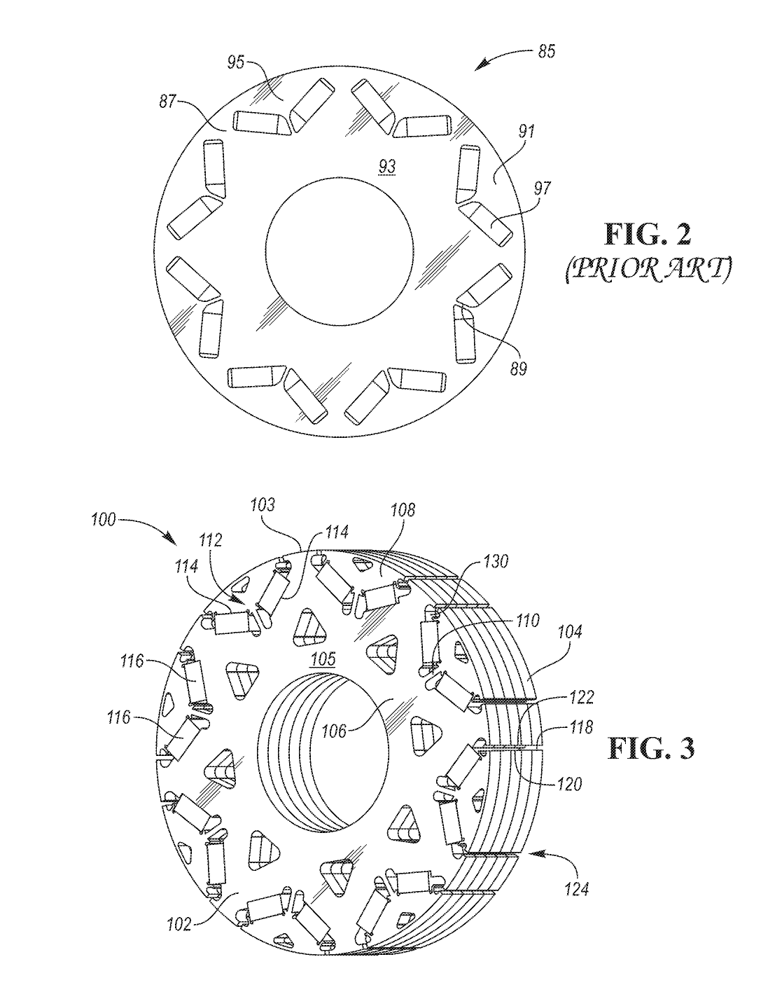

Referring to FIG. 2, in a typical rotor 85 each of the laminations 91 includes side bridges 87 and center bridges 89 that connect the pole portions 95 to the hub portion 93. Ideally, all of the magnetic flux would travel from the magnets 97, across the air gap, and into the windings of the stator. The air, however, has a higher reluctance than the laminations 91 causing leakage through the bridges. This reduces the amount of magnetic flux to the stator windings. The proceeding figures and text describe rotors with improved magnetic flux by removing one or more of the bridges.

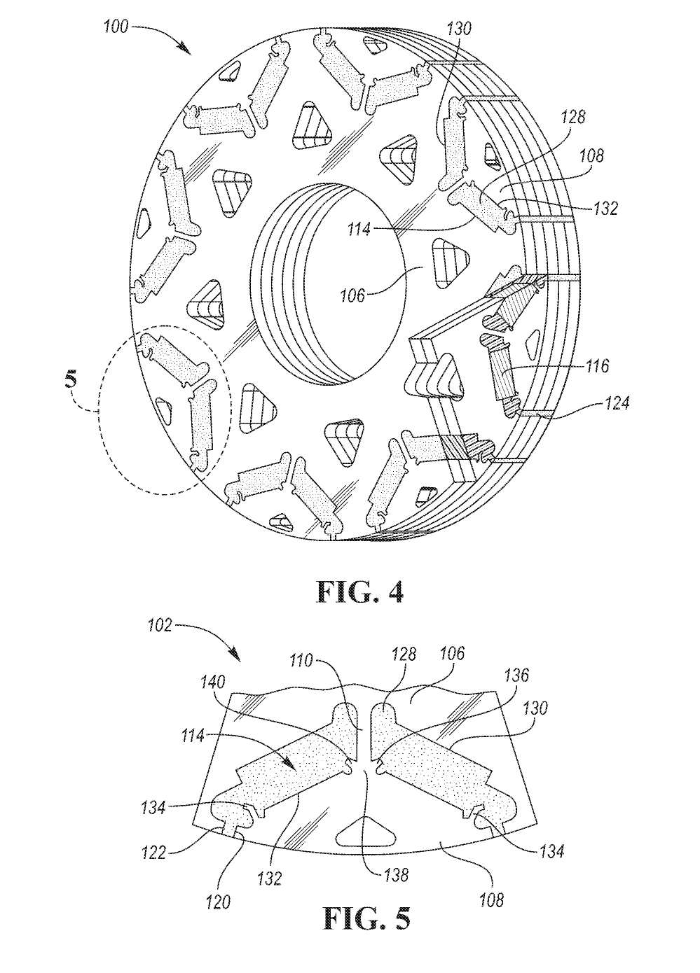

Referring to FIGS. 3 and 4, a rotor 100 includes a rotor core 102 that may be cylindrical in shape having an outer sidewall 103 and a pair of opposing ends 105. The rotor core 102 may be formed of a plurality of stacked laminations 104. Each lamination 104 may include a hub portion 106 and a plurality of pole portions 108 circumferentially arranged around the hub portion 105. The pole portions 108 are connected to the hub portion 106 by center bridges 110. The hub portion 106, the pole portions 108, and the center bridges 110 may be integrally formed with each other. For example, each lamination 104 may be fabricated from a blank that is stamped or otherwise fabricated in to the final geometry shown. The laminations may be steel or other magnetic material.

In the illustrated embodiment, the rotor core 102 includes eight poles 112. Each pole 112 has a pair of adjacent magnet pockets 114 defined by the cooperation of the hub portion 106, the pole portion 108, and the center bridge 110. Each pocket 114 is configured to receive one of the magnets 116. The magnets 116 extend axially through their respective pockets 114 between the opposing ends 105.

To reduce flux leakage from the pole portions 108 to the hub portion 106, the laminations 104 do not include side bridges. An air gap 118 is provided between the edges 120 of the pole portions 108 and the edges 122 of the hub portion 106. This creates slots 124 in the outer sidewall 103 that extend between the ends 105. Each slot 124 may be continuous with associated pockets 114.

To offset a loss of strength due to removal of the side bridges, a bonding material 128 is applied in the pockets 114 to attach the pole portions 108 to the hub portion 106. The bonding material forms a non-magnetic mechanical connection between the outer sides 130 of the hub portions and the inner sides 132 of the pole portions to supplement the center-bridge connection. The bonding material 128 also secures the magnets 116 within their respective pockets 114. The bonding material 128 may be applied to the pockets 114 so that bonding material flows into the slots 124. This provides a non-metallic connection between adjacent edges 120, 122 of the pole and hub portions to further secure the pole portions 108 to the hub portion 106. The bonding material may be epoxy, plastics, or composite materials.

Referring to FIG. 5, each of the pole portions 108 may include one or more projections extending inwardly from the inner side 132 and having an end terminating within a corresponding one of the pockets 114. The projections are embedded within the bonding material 128 to create a mechanical connection between the pole portions 108 and the bonding material 128. In the illustrated embodiment, each of the pole portions 108 includes a pair of side projections 134 and a center projection 136. The side projections 134 are located near the edges 120 and project inwardly from the inner side 132. The side projections 134 may projection at an angle that is oblique to a radially direction of the rotor core 102 to increase the interlock between projections 134 and the bonding material 128. In some embodiments, at least a portion of the projections 134 are perpendicular to the radial direction. The center projections 136 may be located at the end of a corresponding center bridge 110, i.e., the center bridges 110 extend between the hub portion 106 and the center projections 136. Each center projection 136 may include a neck 138 and a head 140 that is wider than the neck 138. Having the head 140 wider than the neck 138 creates a mechanical connection between the bonding material 128 and the pole portion 108 to further secure the pole portion 108 in place.

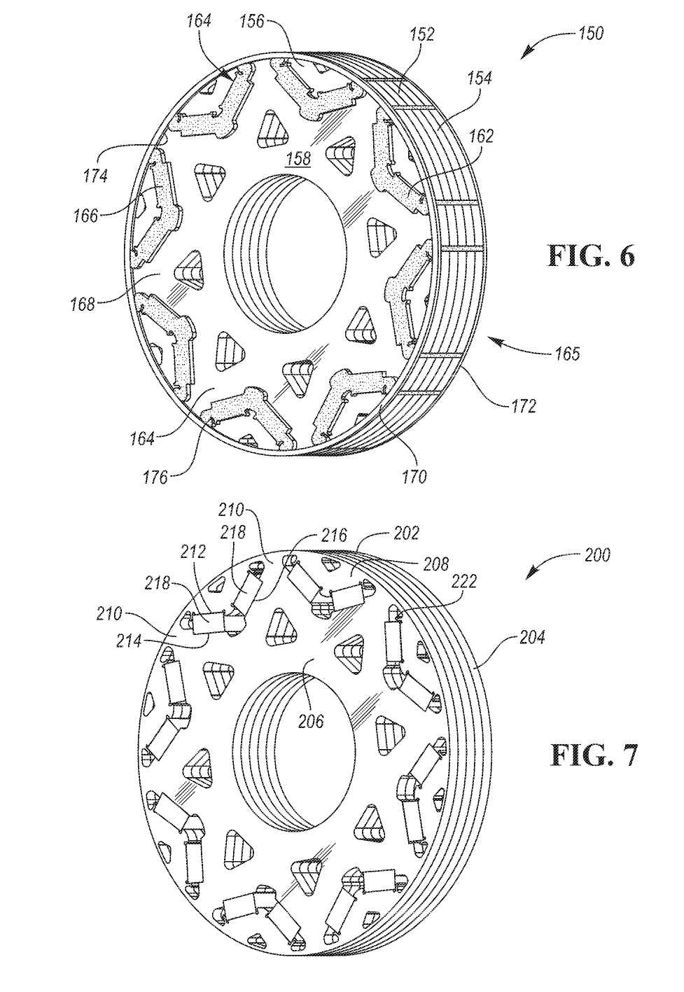

Referring to FIG. 6, another rotor 150 includes a rotor core 152 that may be cylindrical in shape. Similar to the rotor core 52, the rotor core 152 may include a plurality of stacked laminations 154 each having a hub portion 158 and a plurality of pole portions 156 connected with the hub portion 158 by center bridges 160. A plurality of magnet pockets 164 are formed in each of the laminations to receive the magnets (not shown). Bonding material 162, such as epoxy, is applied in each of the pockets 114 such that first raised portions 166 are formed on the first end 164 of the rotor core and second raised portions (not shown) are formed on the second and 165 or the rotor core.

The first raised portions 166 each extends above the outer surface 168 of the end 164, and the second raised portions each extends above the outer surface of the end 165. The raised portions serve as engagement points for the first ring 170 and the second ring 172. The bonding material 162 may adhere the rings to the rotor core 152. The first ring 170 is disposed on the first end 164 and may include an inner surface 174 that engages with the first raised portions 166. The second ring 172 is disposed on the second end 165 and may include an inner surface that engages with the second raised portions. The rings 170, 172 bias the magnets and the pole portions 156 towards the center of the rotor core 152 to resist centrifugal forces that urge the pole portions 108 and the magnets outwardly when the rotor 150 is rotating. The rings 170 and 172 may be formed of any non-magnetic material such as non-magnetic metal, e.g., stainless steel, plastic, composite, or bonding material. The pole portions 156 may include projections 176 that are embedded in the bonding material 162 as described above to further increase the connection between the pole portions 156 and the hub portion 158.

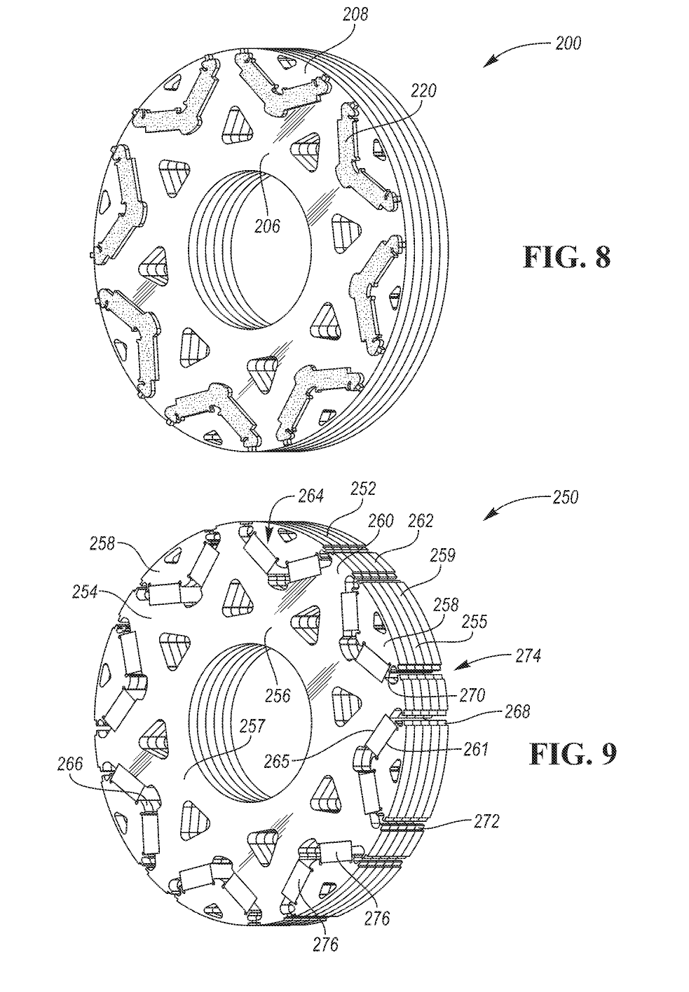

Referring to FIGS. 7 and 8, a rotor 200 includes a rotor core 202 formed of a plurality of laminations 204 each having a hub portion 206 and a plurality of pole portions 208. In this embodiment, the pole portions 208 are connected to the hub portion 206 by side bridges 210 and the center bridges are omitted. Each lamination 204 includes magnet pockets 212 located at the poles. The magnet pockets 212 may include a first arm 214 and a second arm 216 that are arranged to form a generally V-shaped pocket. Each of the poles includes a pair of magnets 218 with one magnet being disposed in the first arm 214 and the other magnet being disposed in the second arm 216. A bonding material 220, such as epoxy, is disposed in the pockets 212 to secure the pole portions 208 to the hub portion 206. The pole portions 208 may include projections 222 embedded in the bonding material 220 as described above. In some embodiments, the rotor 200 may include rings (similar to rings 170 and 172) located on the ends of the rotor core 202 and engaging with raised portions of the bonding material 220 as described above.

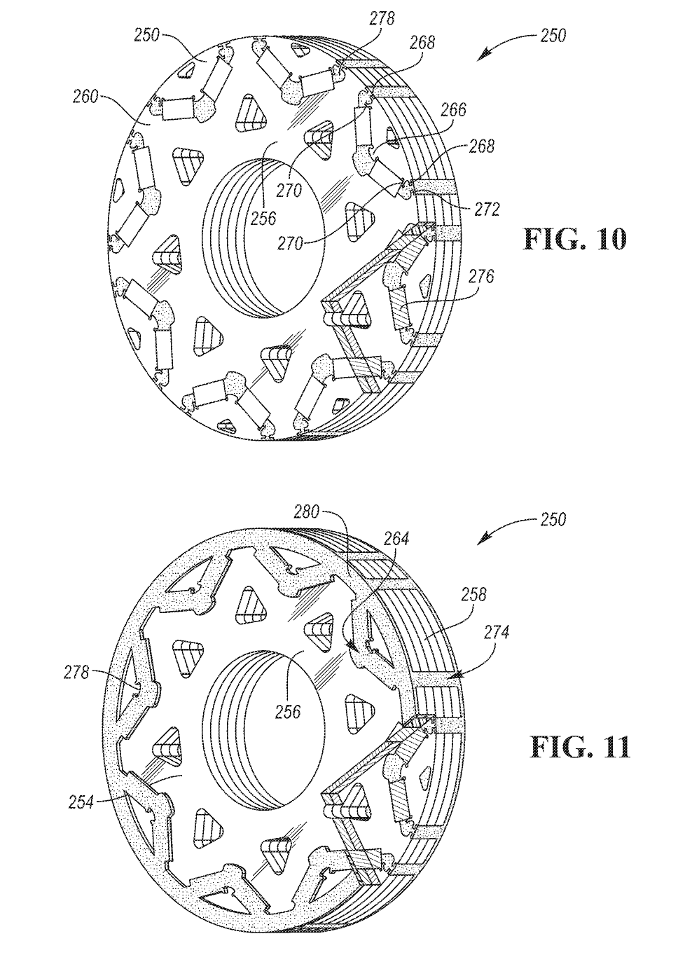

Referring to FIGS. 9 and 10, a rotor 250 includes a rotor core 252 that may be cylindrical in shape and include opposing ends 254 and a sidewall 255. The rotor core 252 may include a hub portion 256 and a plurality of pole portions 258. In this embodiment, all of the bridges are eliminated to form an air gap between the hub portion 256 and the pole portions 258. This air gap magnetically isolates the hub portion 256 from the pole portions 258.

The hub portion 256 may include a plurality of spokes 260 projecting radially outward from a central region 257 of the hub portion 256. Each of the spokes 260 includes a tip 262 that forms a portion of the sidewall 255. The pole portions 258 include outer sides 259 that form the other portion of the sidewall 255. Adjacent spokes 260 cooperate to define slots 264 for receiving the magnets 276 and the pole portions 258. In the illustrated embodiment, the slots 264 are V-shaped having a narrower base and a wider mouth located at the sidewall 255. The pole portions 258 have a generally triangular shape to nest in the slots 264.

One or more magnets 276 are disposed in each of the slots 264. For example, each pole may include a pair of magnets 276 generally arranged in a V-shape. Each magnet 276 may be disposed in the air gap defined between an outer side 265 of one of the spokes 260 and an inner side 261 of one of the pole portions 258.

The rotor 250 does not include any bridges to further reduce flux leakage from the pole portions 258 to the hub portion 256. Thus, the pole portions 258 are not directly connected to the hub portion 256, and an intermediate connecting means is needed to secure the pole portions 258 in place. A bonding material 278, such as epoxy, may be applied in the air gaps to indirectly connect the pole portions 258 to the hub portion 256. The bonding material 278 also secures the magnets 276 in place. This creates a non-magnetic connection that does not contribute to flux leakage.

Each of the pole portions 258 may include a plurality of projections embedded in the bonding material 278 to increase the strength of the connection between the pole portions 258 and the bonding material 278. For example, each pole portion 258 may include a center projection 266, a pair of edge projections 268, and a pair of intermediate projections 270. Each of these projections are embedded in the bonding material 278 and are shaped to form a mechanical connection with the bonding material. The spokes 260 may also include edge projections 272 embedded in the bonding material 278. The sidewall 255 may define a plurality of axially extending slots 274 that are located between the spokes 260 and the pole portions 258. The slots 274 may be continuous with the slots 264 and have bonding material 278 disposed therein.

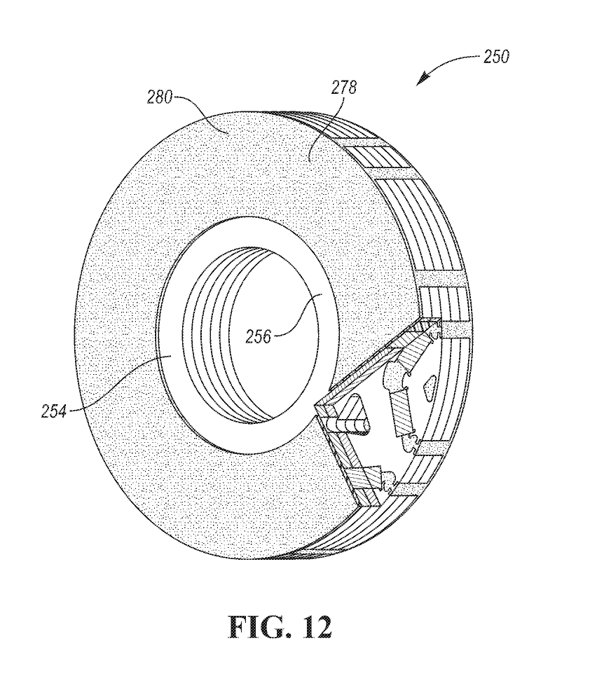

Referring to FIGS. 11 and 12, the bonding material 278 may be applied to the rotor 250 so that a ring 280 is formed on one or both of the ends 254. The ring 280 provides additional support to prevent centrifugal forces from detaching the pole portions 258 form the hub portion 256. The bonding material that forms the ring 280 may be continuous with the bonding material disposed in the slots 264 and the slots 274. The ring 280 may be thinner and only applied around the outer portion of the end 254 as shown in FIG. 11. Or, as shown in FIG. 12, the ring 280 may cover a substantial portion of the end 254 to further increase the retaining force of the ring. “Substantial portion” means more than 50 percent.

In other embodiments, the rotor 250 may include rings (similar to rings 170 and 172) located on the ends 254 of the rotor core 252 made of metal, plastic, or composite. The rings may engage with raised portions of the bonding material 278 as described above.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electric machine comprising:
a stator; and
a rotor supported for rotation within the stator, the rotor including:
a core of stacked laminations each having a hub portion and pole portions cooperating to define pockets,
magnets disposed in the pockets, and
bonding material disposed in the pockets, wherein each of the pole portions has a projection embedded in the bonding material to create a mechanical connection between the pole portions and the bonding material.

2. The electric machine of claim 1, wherein the projection includes a neck and a head that is wider than the neck.

3. The electric machine of claim 1, wherein each of the pole portions includes a second projection spaced apart from the first projection and embedded in the bonding material to create a mechanical connection between the pole portions and the bonding material.

4. The electric machine of claim 1, wherein each of the pole portions is connected to the hub portion by a center bridge that is integrally formed with the pole portion and the hub portion.

5. The electric machine of claim 1, wherein the bonding material is epoxy, plastics, or composite materials.

6. The electric machine of claim 1 wherein the rotor further includes a non-magnetic ring disposed on an end of the core and configured to urge the magnets towards a center of the core.

7. A rotor comprising:
a rotor core defining axially extending pockets circumferentially arranged within the core;
magnets disposed in the pockets;
bonding material disposed in the pockets and having raised portions that extend out of each pocket beyond an end of the core; and
a ring disposed on the end and engaging with the raised portions to bias the magnets towards a center of the core.

8. The rotor of claim 7, wherein the rotor core is formed of a plurality of stacked laminations, wherein each lamination includes a hub portion and a plurality of pole portions circumferentially arranged around the hub portion, and wherein each of the pockets is defined by the cooperation of the hub portion and a corresponding one of the pole portions.

9. The rotor of claim 8, wherein each of the laminations only includes center bridges connecting the pole portions to the hub portion.

10. The rotor of claim 8, wherein at least one of the pole portions includes a projection extending inwardly towards the hub portion and embedded in the boding material to create a mechanical connection between the at least one of the pole portions and the bonding material.

11. The rotor of claim 7, wherein the rotor core is cylindrical and has an outer sidewall defining open slots extending axially along the sidewall, and the bonding material is disposed in each of the slots.

12. The rotor of claim 7, wherein the bonding material has second raised portions the extend out of each pocket beyond a second end of the core that is opposite the end, and further comprising a second ring disposed on the second end and including an inner surface engaging with the second raised portions to bias the magnets towards a center of the core.

13. The rotor of claim 7, wherein the ring is formed of one of non-magnetic metal, plastic, and bonding material.

14. The rotor of claim 7, wherein the ring is formed of bonding material, and the bonding material forming the ring is continuous with the bonding material disposed in the pockets.

15. The rotor of claim 7, wherein the bonding material is epoxy.

16. A rotor comprising:
a cylindrical rotor core including a hub portion having radially projecting spokes that define slots therebetween, and including pole portions each disposed in one of the slots such that the pole portions are not directly connected to the hub portion;
a magnet disposed in each of the slots between the hub portion and a corresponding pole portion; and
a non-magnetic connection attaching each of the pole portions to the hub portion.

17. The rotor of claim 16, wherein the non-magnetic connection is epoxy, plastics, or composite material disposed in the slots and bonded to the hub portion, the pole portions, and the magnets.

18. The rotor of claim 17, wherein each of the pole portions includes at least one projection extending towards a corresponding one of the spokes, and each of the projections is embedded in the non-magnetic connection.

19. The rotor of claim 17, wherein the non-magnetic connection has raised portions that extend beyond an end of the rotor core, and further comprising a ring disposed on the end of the rotor core and including an inner surface engaging with the raised portions to bias the magnets towards a center of the core.

20. The rotor of claim 16, wherein the rotor core has an outer sidewall defining open slots located between adjacent spokes and pole portions and extending axially along the outer sidewall, and wherein bonding material is disposed in each of the open slots.
